(19) United States
(12) Patent Application Publication
(10) Pub. No.: US 2008/0098973 A1
(43) Pub. Date: May 1, 2008

(54) Photoconductive Ignition System

(75) Inventors: Yusuke Niwa, Machida-shi (JP); Kenjiro Matsushita, Shinjuku-ku (JP); Teruyoshi Mihara, Yokosuka-shi (JP); Kohji Masuda, Shinagawa-ku (JP); Hiroyuki Kaneko, Yokohama-shi (JP); Norihiko Kiritani, Yokosuka-shi (JP)

Correspondence Address: YOUNG & BASILE, P.C., 3001 WEST BIG BEAVER ROAD, SUITE 624, TROY, MI, 48084, US

(73) Assignee: NISSAN MOTOR CO., LTD., Yokohama-shi, Kanagawa (JP)

(21) Appl. No.: 11/815,201

(22) PCT Filed: Mar. 17, 2006
(86) PCT No.: PCT/IB06/00604

§ 371 Date: Jul. 31, 2007

(30) Foreign Application Priority Data
Mar. 30, 2005 (JP) 2005-098507
Mar. 3, 2006 (JP) 2006-057858

(51) Int. Cl. F02P 23/04

(52) U.S. Cl. 123/143 B

(57) ABSTRACT

The disclosure relates to a photoconductive ignition system including a photoconductor configured to contact an oxidant-fuel gas mixture, and a light source providing irradiating light to a surface of the photoconductor. The photoconductor absorbs at least some of the light from the light source, which causes a variation in electrical potential at the surface of the photoconductor, thereby igniting the oxidant-fuel gas mixture. The disclosure further relates to a method of activating an oxidant-fuel gas mixture by exposing a photoconductor surface to the gas mixture and irradiating the surface with a light source emitting light at a wavelength corresponding to an energy level greater than a band gap energy level of the photoconductor, thereby activating the gas mixture in a combustion reaction.

This application claims priority from Japanese Patent Application No. 2005-098507, filed Mar. 30, 2005, and Japanese Patent Application No. 2006-057858, filed Mar. 3, 2006, the entire disclosure of each being incorporated herein by reference.

### TECHNICAL FIELD

The invention relates to fuel ignition systems, and more specifically, to ignition systems that use light energy to ignite an oxidant-fuel gas mixture in a combustion engine.

### BACKGROUND

The operating efficiency and power output of a fuel combustion engine can be influenced by the speed and consistency of ignition of the oxidant-fuel gas mixture. Various methods, including electronic fuel injection and fuel ignition systems, have been used to improve engine operating efficiency and power output. However, the art continues to seek new and improved methods to rapidly and consistently ignite the fuel-air mixture in a combustion engine.

A number of operating anomalies may undesirably reduce the power output from a combustion engine. For example, knocking may occur in the combustion chamber of a vehicle engine operating at high compression ratio. Knocking is an undesirable pre-ignition of the fuel-air mixture resulting from the high compression ratio in the combustion chamber. Furthermore, in engines operating with fuel-lean oxidant-fuel gas mixtures, undesirable turbulent gas currents, for example swirling or tumbling, may be created. Although turbulence may act to increase the flame propagation velocity, turbulence also may make it more difficult to initiate ignition of the oxidant-fuel gas mixture.

Technology has been proposed to improve the efficiency of ignition by focusing light on or within the air-fuel mixture. Furthermore, technology has been reported that improves thermal energy conversion efficiency of the air-fuel mixture by irradiating light on the ignition element. Although light is irradiated in each of these methods, the light provides thermal energy directly to the air-fuel mixture, thereby thermally activating the combustion reaction.

### SUMMARY

However, known systems for igniting an air-fuel mixture using light have as a principal problem that the efficiency of energy necessary for ignition is extremely low. In a conventional system that ignites the air-fuel mixture using light, an ignition seed or starter flame is formed by colliding molecules with each other after raising the temperature of the air-fuel gas mixture by directly irradiating light into the flowing air-fuel mixture, which heats the gas mixture to a flashpoint temperature or auto-ignition temperature for the fuel. In other words, energy efficiency is low because light energy is converted into thermal energy, and the resulting heat is used to augment initiation of the combustion reaction.

In one embodiment, the invention relates to a photoconductive ignition system including a photoconductor in contact with an oxidant-fuel gas mixture, and a light source providing irradiating light to a surface of the photoconductor. The photoconductor absorbs at least some of the light irradiated from the light source, which causes a variation in electrical potential at the surface of the photoconductor, thereby igniting the oxidant-fuel gas mixture. In some embodiments, the light applied to the surface of the photoconductor may cause a photocatalytic reaction within at least a portion of the oxidant-fuel gas mixture adjacent the surface, thereby igniting the oxidant-fuel gas mixture. In certain embodiments, the light source may be a Xenon lamp or a laser.

In another embodiment, the invention relates to an oxidant-fuel gas ignition device, including a means for generating radiated light, and a means for igniting an oxidant-fuel gas mixture upon exposure to at least a portion of the radiated light. The means for igniting an oxidant-fuel gas mixture absorbs at least some of the radiated light, forming electron holes by electronic excitation, and thereby igniting the gas mixture.

In other embodiments, the invention relates to a method for activating an oxidant-fuel gas mixture by exposing a photoconductor surface to the gas mixture and irradiating the surface with a light source emitting light at a wavelength producing a radiation energy greater than a band gap energy of the photoconductor, thereby activating the gas mixture in a combustion reaction.

The ignition system, device and method may provide more rapid and consistent ignition of an oxidant-fuel gas mixture in a fuel combustion process. This rapid and consistent ignition may result in enhanced energy efficiency compared to conventional ignition systems that use light sources to thermally activate an air-fuel mixture.

For example, in certain embodiments, the ignition system and device may provide multiple ignition points within a combustion chamber, thereby permitting selection of desired ignition points to produce more uniform ignition of the oxidant-fuel gas mixture and thus achieve more complete fuel combustion.

Furthermore, in some embodiments the invention may overcome limitations of known ignition systems for combustion engines, such as the undesirable time delay associated with propagation of the activating energy throughout the air-fuel mixture. In particular, the invention may result in extremely short propagation times on the order of dozens of nanoseconds as opposed to thousands of nanoseconds for conventional ignition systems using, for example, spark plugs or glow plugs.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a schematic side view diagram illustrating a photoconductive ignition system according to an exemplary embodiment of the invention.

FIG. 2 is a schematic cross-sectional view diagram illustrating another photoconductive ignition system according to another exemplary embodiment of the invention.

FIG. 3 is a schematic side view diagram illustrating an additional photoconductive ignition system according to a further exemplary embodiment of the invention.

FIG. 4 is a graphical diagram illustrating light intensity as a function of wavelength useful in confirming the photo-initiated reaction of propane fuel gas by a photoconductive ignition system according to other embodiments of the invention.

### DETAILED DESCRIPTION

The photoconductive ignition system, device and method described herein initiates combustion of an air-fuel gas mixture by irradiating a photoconductor surface using a light source. While not wishing to be bound by any particular theory, applicants presently believe that electron holes are formed by excitation of electrons on the irradiated surface of the photoconductor, thereby causing a variation in electrical potential at the surface of the photoconductor, thereby activating the combustion reaction of the gas mixture, causing ignition of the fuel gas. In some embodiments, the light applied to the surface of the photoconductor may cause a photocatalytic reaction within at least a portion of the oxidant-fuel gas mixture adjacent the surface. This photocatalytic reaction may reduce the light energy required to initiate combustion of the oxidant-fuel gas mixture, .at least in part because light energy is utilized to directly activate, rather than heat, the oxidant-fuel gas mixture.

Various embodiments of the photoconductive ignition system according to the present invention are described in detail in the following detailed description. However, the scope of the invention is not limited to the specifically described embodiments, but encompasses these embodiments, as well as any additional embodiments that include all elements of the claims and their equivalents. As used herein, the term “percent” or “%” indicates a percentage by mass unless specified otherwise.

In certain embodiments, the photoconductive ignition system of the invention includes a photoconductor and a light source. More specifically, in some embodiments, the photoconductive ignition system of the present invention includes a photoconductor installed to come in contact with an oxidant-fuel gas mixture composed of an oxidant gas and a fuel gas, and a light source that irradiates light on a surface of the photoconductor. The photoconductor is preferably installed to come in contact with the oxidant-fuel gas mixture that is to be ignited within a combustion chamber.

For example, the photoconductor may be installed or applied inside the combustion chamber of a combustion engine, for example on the inner wall, piston crown, cylinder head, breather valve, and the like of an internal combustion engine. The photoconductor may be applied to the inner surface of the piston head engaged with the inner surface of a combustion cylinder, which may also have a surface coated with an applied photoconductor. The photoconductor may be applied as a substantially uniform layer over the inner surface of the combustion chamber. Alternatively, the photoconductor may be applied as a non-uniform or discontinuous layer, for example, as a pattern of dots, bands, strips, and the like.

The photoconductor absorbs at least some of the light irradiated from the light source. Furthermore, in a presently preferred embodiment, the light source may be selected to emit light at a wavelength having an energy level that exceeds the band-gap energy level of the photoconductor. It is preferable for the light source to irradiate light at wavelengths that exceed the band-gap of the relevant photoconductor because light energy must be absorbed that exceeds the specific band-gap that a photoconductor has in order to form electron holes in conjunction with exciting electrons from the valence band to the conduction band. In addition, the relationship between the band-gap energy and the wavelength of the light irradiated by a radiation source is expressed in the following formula:
wavelength(nm)=1,240/[band gap energy(eV)] (1)

At that time, the excitation of electrons held by the photoconductor and the formation of electron holes progresses more efficiently, so it is possible to ignite the oxidant-fuel gas mixture within a short period of time. Furthermore, as for said light source, it is necessary only to irradiate light that is able to shift the photoconductor into a high-energy state within a short time, and laser, light-emitting diode (LED), etc., can be used. In particular, from the perspective of stable ignition within a short time, it is preferable to use a high-output laser as the light source used in an internal combustion engine because high power density is necessary. Alternatively, a Xenon lamp, for example, a Xenon flash lamp, may be used advantageously as the light source. Preferred light sources irradiate light having a wavelength from about 150 nanometers to about 1000 nanometers, more preferably from about 200 to about 800 nm.

In addition, it is possible to install multiple light sources, or alternatively, light from a single source may be split by through an optical system device (e.g. a splitter, condenser, and the like) and adjusting the focal point. Furthermore, the irradiation of light can be continuous or pulsed by periodically cycling light emission from an off state to an on state in correspondence to an inflow or outflow of the oxidant-fuel gas mixture to a combustion chamber.

The light source irradiates light on the photoconductor, which causes the photoconductor to absorb at least part of that light. The resulting excitation of the electrons in the photoconductor is believed to form electron holes on the surface. The electrons and electron holes are then believed to react with the oxidant-fuel gas mixture to activate and ignite the mixture via a photocatalytic reaction.

Suitable photoconductive materials include metal-oxide photoconductors, chalcogenide photoconductors, and amorphous silicon photoconductors described in, for example, Handbook of Imaging Technology, A. S. Diamond and D. S. Weiss, eds., 2^{nd} Ed., (Marcel Dekker, NY: 2002), pages 329-436, the entire disclosure of which is incorporated herein by reference. Preferably, the photoconductor or photoconductive material absorbs light having a wavelength from about 150 nanometers to about 1000 nanometers. More preferably, the photoconductor or photoconductive material absorbs light at a wavelength producing a radiation energy greater than a band gap energy of the photo conductor.

It is possible to use optical semi-conductors, pigments (organometallic complex), and the like as the photoconductor as long as the material generates electric conduction by forming electron holes in conjunction with excited electrons when irradiated by light. Preferred photoconductive materials are thermally stable at the temperature of the combustion reaction, generally from about 200° C. to about 1,000° C. Exemplary photoconductors include metal oxides such as titanium oxides, zinc oxides, niobium oxides, tantalum oxides, gallium oxides, strontium oxides, iron oxides, tungsten oxides, or tin oxides and combinations thereof; chalcogenides such as selenium and alloys of selenium with tellurium or arsenic; and amorphous silicon.

The photoconductor may include at least one material selected from a charge generation material, an electron transport material, a hole transport material, an electron acceptor material, an electron donor material, or a binder material. Suitable materials are described in, for example, Paul M. Borsenberger and David S. Weiss, Organic Photoreceptors for Imaging Systems, (Marcel Dekker, NY: 1993), pages 101-266, the entire disclosure of which is incorporated herein by reference. Preferred materials are thermally stable at the temperature of the combustion reaction, generally from about 200° C. to about 1,000° C. In particular, the photoconductor may include an electron transport material and a charge generation material combined as a mixture in a single photoconductive layer. Alternatively, the photoconductor may include a multi-layer structure, for example, a dual layer of an electron transport material overlaying a charge generation material.

The combustion engine is not particularly limited in fuel, actuation technology, cycle, number of cylinders, cylinder format, cooling system, valve mechanism, number of valves, etc., as long as power is obtained by combusting an oxidant-fuel gas mixture. According to the photoconductive ignition system of the invention, it is preferable to convert thermal energy to mechanical energy when an oxidant-fuel gas mixture is ignited within the combustion chamber of a combustion engine. The combustion engine may be an internal combustion engine, for example, a multi-cylinder engine with combustion cylinders arranged in-line or in a V-shaped arrangement, or a rotary engine (for example, a Wankel rotary engine). The combustion engine may be used to power a motor vehicle, for example, a motorcycle, an automobile, a truck, a locomotive, a boat, or an aircraft.

In addition, the oxidant-fuel gas mixture is not particularly limited. Preferably, the oxidant gas is selected from oxygen, air, nitrous oxide, or nitromethane. Preferably, the fuel gas is selected from hydrogen, a hydrocarbon, an alcohol, an ether, a ketone, or an ester. Preferably, the oxidant-fuel gas mixture falls within the combustible limits defined by the lower flammability limit and upper flammability limit, expressed in volumetric units, for that particular fuel in that particular oxidant gas. For example, the fuel gas (e.g. gasoline, kerosene, natural gas, alcohol, and the like) may be combined with air at a ratio that falls between the lower flammability limit and the upper flammability limit determined for that fuel gas in air.

In certain embodiments, a means for generating radiated light (e.g. a light source such as a laser or Xenon lamp), and a means for igniting an oxidant-fuel gas mixture upon exposure to at least a portion of the radiated light (e.g. a photoconductor) is provided in an oxidant-fuel gas ignition device. Without wishing to be bound by any particular theory, applicants presently believe that the means for igniting the oxidant-fuel gas mixture absorbs at least some of the radiated light, forming electron holes by electronic excitation, and thereby initiating an electrical discharge to ignite the oxidant-fuel gas mixture.

In other embodiments, a method for activating an oxidant-fuel gas mixture is provided, in which a photoconductor surface is exposed to an oxidant-fuel gas mixture, and the photoconductor surface absorbs light irradiated by a light source emitting light at a wavelength producing a radiation energy greater than a band gap energy of the photoconductor, thereby initiating an electrical discharge and igniting the gas mixture.

The invention is described in further detail by means of the following Examples and Figures, but the invention is not limited to these specific embodiments.

### EXAMPLES

### Example 1

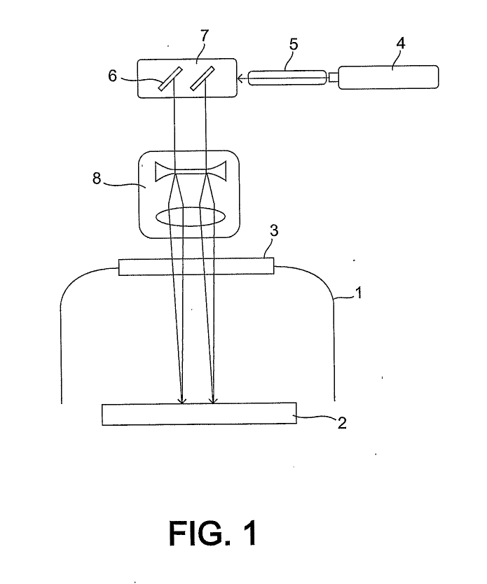

FIG. 1 shows an example of an application of the photoconductive ignition system. A combustion chamber 1 comprising an optically transparent window 3 is provided in which a photoconductor 2 is installed internally. Furthermore, in the particular embodiment illustrated by FIG. 1, a light generation assembly 4-8 is shown positioned external to the combustion chamber 1, including, for example, a laser diode light source 4, an optical fiber 5, a mirror 6, a beam-splitter 7 and a lens assembly.

The oxidant-fuel gas mixture is ignited after a specified quantity of oxidant-fuel gas mixture flows into the combustion chamber 1, laser is oscillated by means of a laser diode 4, passing through an optical fiber cable 5, and distributed into an arbitrary number of beams by means of a beam-splitter 7, passing through a lens assembly 8 and window 3, and focused in a desired position on the surface of the photoconductor 2 inside the combustion chamber 1.

### Example 2

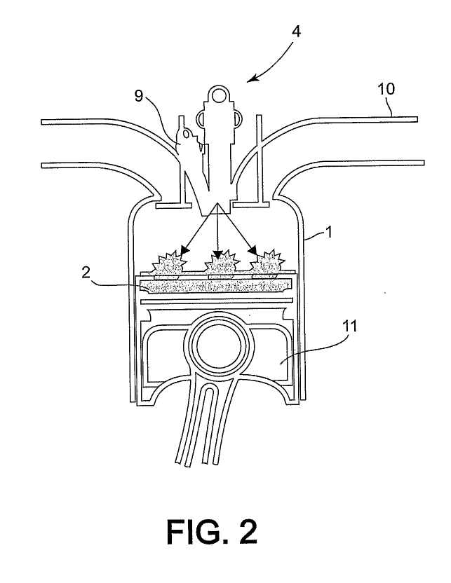

FIG. 2 shows an example of another photoconductive ignition system according to another exemplary embodiment of the present invention. A photoconductor 2 (e.g. titanium dioxide) is installed on the crown of piston 11 engaged with an interior surface of a combustion chamber 1 (e.g. engine cylinder) of a gasoline engine as shown in FIG. 2. A light generation assembly 4 (including, e.g. a laser diode) was positioned to irradiate desired positions on the surface of the photoconductor 2 with laser light at a wavelength corresponding to an energy level greater than a band gap energy level of the photoconductor. The photoconductor 2 absorbs at least some of the light irradiated from the light generation assembly 4, thereby forming electron holes by electronic excitation of the surface and igniting the oxidant-fuel gas mixture.

Furthermore, a combustion injection valve 9 and air inlet-exhaust gas outlet manifold 10 are shown positioned proximate to the combustion chamber 1, to facilitate formation of the oxidant-fuel gas mixture in the combustion chamber on the down-stroke of the piston 11, and facilitate the removal of combustion products as exhaust gas from the combustion chamber 1 on the up-stroke of the piston 11.

In an illustrative example of a method of using the photoconductive ignition system of FIG. 2, an oxidant-fuel gas mixture (e.g. propane in air) was admitted to the combustion chamber 1 and compressed by moving the piston 11 upward, and when the piston 11 was close to the top dead center position, the photoconductor 2 was irradiated at desired positions across the surface of the photoconductor 2 using a 390-nm wavelength beam of laser light produced by the light generation assembly 4. After laser irradiation, the oxidant-fuel gas mixture was ignited, and the combustion process was initiated.

### Comparative Example 1

The titanium dioxide photoconductor of Example 2 was replaced with aluminum oxide on the crown of the piston 11, and the oxidant-fuel gas mixture was ignited using the same procedure as in Example 2. When igniting and initiating combustion of the oxidant-fuel gas mixture using the photoconductive ignition system according to the embodiments illustrated by Examples 1 and 2, the energy efficiency of the engine was markedly improved over conventional ignition methods. Furthermore, it was discovered that the ignition/combustion efficiency of combustion mixture using the titanium oxide photoconductor of Example 2 was higher (ignition at approximately 40% output) than that using aluminum oxide in Comparative Example 1.

### Example 3

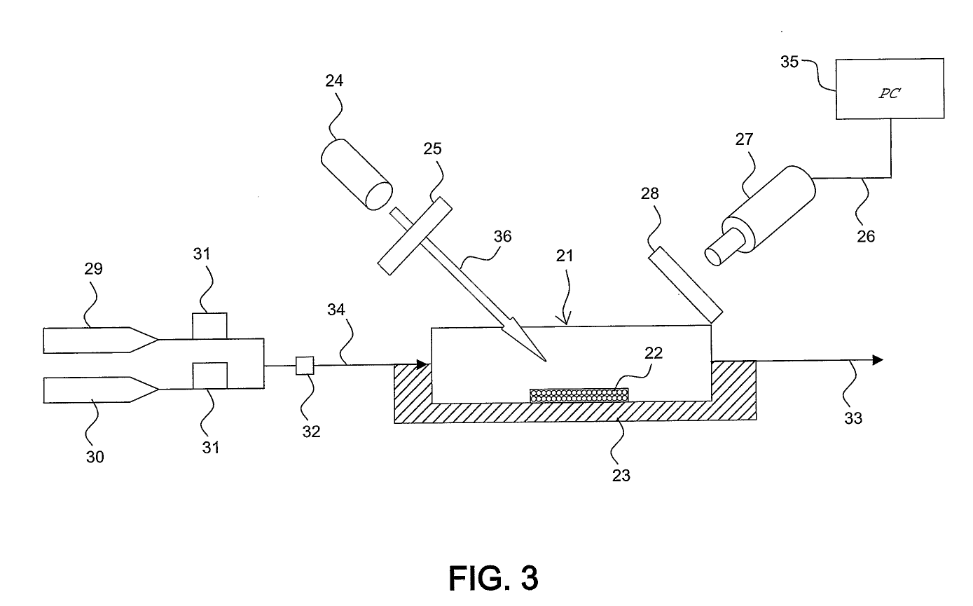

FIG. 3 shows an example of another application of the photoconductive ignition system. The predetermined flow rate (propane: 100 cm³/min., Air: 1,000 cm³/min.) of fuel 29 and air 30 was set using mass flow controllers 31, and the mixed oxidant-fuel gas mixture 34 was supplied to the quartz reaction tube combustion chamber 21. Ten grams of photoconductor 22 were installed in the interior of the combustion chamber 21 to create a space in the upper part of the combustion chamber 21. The lower part of the combustion chamber 21 in which the photoconductor 22 was installed was heated at 400° C. using an electric furnace 23. Titanium dioxide was selected for the photoconductor 22.

A 300-watt Xenon lamp was used for the excitation light source 24 used to irradiate the combustion chamber 21. The light emitted by the Xenon lamp 24 was passed through a low-pass filter 25 to produce a 300-400 nm ultraviolet band of light 36 used to irradiate the surface of the photoconductor 22. The oxidant-fuel gas mixture 34 was ignited to initiate combustion of the fuel gas, and the resulting exhaust gases 33 were removed from the combustion chamber 21. An absorbance spectrum was measured using a Charge Coupled Device 27 connected to a personal computer (PC) 35 via optical fiber 26, after removing ultraviolet light from the irradiated light using a high-pass optical filter 29. The emitted light was observed to be have a peak wavelength of about 640 nm (Example 3) when propane C₃H₈) was used as the fuel gas, and air was used as the oxidant.

### Comparative Example 2

This is the same as Example 1 except that light is not irradiated at a peak wavelength.

### Comparative Example 3

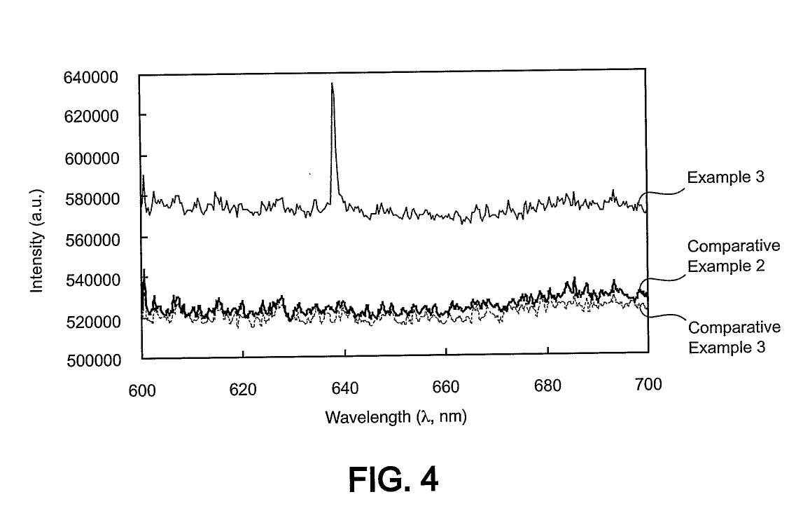

This is the same as Example 1, except that the reaction gas was only air flowing at 1,000 cm³/min. In FIG. 4, part of the oxidant-fuel gas mixture on photoconductor 22 is ignited by irradiated excitation light, and a spectrum is created by a CM3D 27 via optical fiber 26 after removing ultraviolet light from the irradiated light by means of a high-pass filter 29. The emitted light was observed to be about 640 nm (Example 3) when propane is the fuel gas and air is the oxidant and light from the light source was irradiated on the surface of the photoconductor 22. However, as shown in FIG. 5, emitted light was not observed when light was not irradiated (Comparative Example 2), or when only air was supplied to the combustion chamber 21 (Comparative Example 3). From these results, the observed light emission peak in Example 3 is understood to result from the initiation of combustion of the oxidant-fuel gas mixture due to photocatalysis initiated by the light source 24.

In addition, photoconductive ignition system mentioned in Examples 1, 2, and 3 are only one embodiment of the invention, and the invention is not particularly limited to these specific embodiments. For example, ignition may be advantageously induced at the same time as ignition of the oxidant-fuel gas mixture in the combustion chamber, by means of an ignition plug (e.g. a spark plug or glow plug) in conjunction with the photoconductive ignition system, making it possible to further increase the combustion efficiency of the oxidant-fuel gas mixture.

Various embodiments of the invention have been described. These and other embodiments are within the scope of the following claims.

1. A photoconductive ignition system, comprising:
a photoconductor in contact with an oxidant-fuel gas mixture; and
a light source, wherein light emitted by the source is applied to a surface of the photoconductor; wherein the photoconductor absorbs at least some of the light from the light source, which causes a variation in electrical potential at the surface of the photoconductor, thereby igniting the oxidant-fuel gas mixture.

2. The photoconductive ignition system of claim 1, wherein the light applied to the surface of the photoconductor causes a photocatalytic reaction within at least a portion of the oxidant-fuel gas mixture adjacent the surface.

3. The photoconductive ignition system of claim 1, wherein the light source is selected from the group consisting of a Xenon lamp and a laser.

4. The photoconductive ignition system of claim 1, wherein the light source emits light at a wavelength corresponding to an energy level greater than a band gap energy level of the photoconductor.

5. The photoconductive ignition system of claim 1, wherein the light source emits light having a wavelength from about 150 nanometers to about 1000 nanometers.

6. The photoconductive ignition system of claim 1, wherein the photoconductor absorbs light having a wavelength from about 150 nanometers to about 1000 nanometers.

7. The photoconductive ignition system of claim 1, wherein the photoconductor is selected from the group consisting of metal-oxide photoconductors, chalcogenide photoconductors, and amorphous silicon photoconductors.

8. The photoconductive ignition system of claim 1, wherein the photoconductor comprises at least one material selected from the group consisting of a charge generation material, an electron transport material, a hole transport material, an electron acceptor material, an electron donor material, and a binder material.

9. The photoconductive ignition system of claim 1, wherein the photoconductor comprises an electron transport material and a charge generation material applied as a mixture in a single layer.

10. The photoconductive ignition system of claim 1, wherein the oxidant-fuel gas mixture comprises at least one oxidant gas selected from the group consisting of oxygen, air, nitrous oxide, or and nitromethane.

11. The photoconductive ignition system of claim 1, wherein the oxidant-fuel gas mixture comprises at least one fuel gas selected from the consisting of hydrogen, a hydrocarbon, an alcohol, an ether, a ketone, and an ester.

12. The photoconductive ignition system of claim 1, further comprising a combustion chamber comprising the photoconductor surface, wherein igniting the oxidant-fuel gas mixture is initiated within the combustion chamber.

13. The photoconductive ignition system of claim 12, wherein the photoconductor is applied to an interior surface of the combustion chamber.

14. The photoconductive ignition system of claim 12, further comprising a piston engaged with an interior surface of the combustion chamber, wherein the photoconductor is applied to a surface of the piston exposed to the interior surface of the combustion chamber.

15. The photoconductive ignition of claim 1, wherein ignition of the gas mixture converts thermal energy into mechanical energy.

16. The photoconductive ignition system of claim 15, wherein thermal energy is converted into mechanical energy upon ignition of the gas mixture within a combustion chamber of a fuel combustion engine.

17. The photoconductive ignition system of claim 16, wherein the fuel combustion engine is an internal combustion engine.

18. The photoconductive ignition system of claim 17, wherein the fuel combustion engine provides power to a motor vehicle.

19. The photoconductive ignition system of claim 18, wherein the motor vehicle is selected from the group consisting of a motorcycle, an automobile, a truck, a locomotive, a boat, and an aircraft.

20. An oxidant-fuel gas ignition device, comprising:
a means for generating radiated light; and
a means for igniting an oxidant-fuel gas mixture upon exposure to at least a portion of the radiated light;
wherein the means for igniting an oxidant-fuel gas mixture absorbs at least some of the radiated light, forming electron holes by electronic excitation, and thereby igniting the gas mixture.

21. A method for activating an oxidant-fuel gas mixture, comprising:
exposing a photoconductor surface to an oxidant-fuel gas mixture; and
irradiating the photoconductor surface with a light source emitting light at a wavelength greater than a band gap wavelength of the photoconductor;
wherein the photoconductor absorbs at least some of the light irradiated from the light source, thereby activating the gas mixture in a combustion reaction.
